(19) United States
(12) Patent Application Publication
(10) Pub. No.: US 2016/0249045 A1
(43) Pub. Date: Aug. 25, 2016

(54) DISPLAY DEVICE AND METHOD FOR DISPLAYING IMAGES

(71) Applicant: SHENZHEN CHINA STAR OPTOELECTRONICS TECHNOLOGY CO., LTD., Shenzhen, Guangdong (CN)

(72) Inventor: Xiangyang XU, Shenzhen, Guangdong (CN)

(21) Appl. No.: 14/386,704

(22) PCT Filed: Jun. 17, 2014
(86) PCT No.: PCT/CN2014/080058

§ 371 Date: Sep. 19, 2014

(30) Foreign Application Priority Data
Jun. 7, 2014 (CN) 201410250978.3

(51) Int. Cl. H04N 13/04; H04N 13/00

(52) U.S. Cl. CPC H04N 13/0454; H04N 13/0409; H04N 13/0033

(57) ABSTRACT

The present invention proposes a method and a display device for displaying images. A display panel of the display device includes a 3D display circular polarizer and a TFT array substrate. The TFT array substrate includes a first sub-pixel column and a second sub-pixel column set up in parallel. The first sub-pixel column has at least two first sub pixels arranged in array in the first direction. The second sub-pixel column has at least two second sub-pixels arranged in array in the first direction. The first direction is parallel to a line where the first sub-pixel column locates. The 3D display circular polarizer is stacked with the display panel.

### BACKGROUND OF THE INVENTION

1. Field of the Invention

The present invention relates to a display technology field, more particularly, to a display device and a method for displaying images.

2. Description of the Prior Art

Traditional three-dimension (3D) image display device is capable of switching display modes between 2D image and 3D image to display 2D or 3D images.

Conventional 3D image display device adopts the light-division schemeor the time-division scheme when displaying 3D images.

In practice, the inventor has found the below problem in the prior art at least:

The 3D image display effects in the two above schemes are worse and easily result in human-body fatigue and visual impairment,

Therefore, it is necessary to provide a new scheme to solve the above technical problem.

### SUMMARY OF THE INVENTION

An object of the present invention is to provide a display device and a method for displaying images thereof to improve 3D image display effect.

According to the present invention, a display device comprising a display panel, the display panel comprises a Thin Film Transistor (TFT) array substrate, a 3D display circular polarizer, and a control circuit. The Thin Film Transistor (TFT) array substrate comprises at least two sub-pixel column sets, at least two of the sub-pixel column sets arranged in array. The sub-pixel column sets comprises: a first sub-pixel column and a second sub-pixel column set up in parallel, the first sub-pixel column comprising at least two first sub-pixels, at least two of the first sub-pixels arranged in array in the first direction, the second sub-pixel column comprising at least two second sub-pixels, at least two of the second sub-pixels arranged in array in the first direction. The first direction is parallel to a line where the first sub-pixel column locates. The 3D display circular polarizer is stacked with the display panel. The control circuit is used for receiving display control signals and controlling the display panel to switch to a 2D image display mode or a 3D image display mode according to the display control signals. Color of the first sub-pixel and the second sub-pixel in the same sub-pixel column set is identical, but that of the two adjacent sub-pixel column sets are not identical. The 3D display circular polarizer is used for polarizing displayed images into left-handed or right-handed circularly polarized displayed images when the display device is in the 3D display mode.

In one aspect of the present invention, the 3D display circular polarizer arranges at least one left-handed circular polarization region and at least one right-handed circular polarization region. Both the left-handed circular polarization region and the right-handed circular polarization region correspond to one sub-pixel area, and the sub-pixel area is area the first sub-pixel or the second sub-pixel correspond to.

In another aspect of the present invention, the first sub-pixel corresponds to one of the left-handed circular polarization region and the right-handed circular polarization region, the second sub-pixel adjacent to the first sub-pixel in a second direction corresponds to the other of the left-handed circular polarization region and the right-handed circular polarization region. The second direction is perpendicular to the first direction.

In another aspect of the present invention, in the first direction, the two adjacent first sub-pixels respectively correspond to the left-handed circular polarization region and the right-handed circular polarization region; in the first direction, the two adjacent second sub-pixels respectively correspond to the right-handed circular polarization region and the left-handed circular polarization region.

In another aspect of the present invention, in the first direction, the two adjacent first sub-pixels both correspond to one of the left-handed circular polarization region and the right-handed circular polarization region; in the first direction, the two adjacent second sub-pixels both correspond to the other of the left-handed circular polarization region and the right-handed circular polarization region.

In another aspect of the present invention, in the 3D image display mode, the control circuit controls a sub-pixel area corresponding to the left-handed circular polarization region to display a first images in a displaying period of one frame of images; in the 3D image display mode, the control circuit further controls a sub-pixel area corresponding to the right-handed circular polarization region to display a second images in a displaying period of a continuous next frame of the one frame.

In still another aspect of the present invention, in a displaying period of any one frame of images, the control circuit controls any two adjacent sub-pixels in the TFT array substrate in the display and the non-display state respectively or in the non-display and the display state respectively.

In yet another aspect of the present invention, in the 2D image display mode, the control circuit also controls the sub-pixel area corresponding to the left-handed circular polarization region and the sub-pixel area corresponding to the right-handed circular polarization region to simultaneously display a third images.

According to the present invention, a display device comprises a display panel. The display panel comprises: a Thin Film Transistor (TFT) array substrate, a 3D display circular polarizer, and a control circuit. The Thin Film Transistor (TFT) array substrate comprises at least two sub-pixel column sets, at least two of the sub-pixel column sets arranged in array. The sub-pixel column sets comprises: a first sub-pixel column and a second sub-pixel column set up in parallel, the first sub-pixel column comprising at least two first sub-pixels, at least two of the first sub-pixels arranged in array in the first direction, the second sub-pixel column comprising at least two second sub-pixels, at least two of the second sub-pixels arranged in array in the first direction. The first direction is parallel to a line where the first sub-pixel column locates. The 3D display circular polarizer is stacked with the display panel. The control circuit is used for receiving display control signals and controlling the display panel to switch to a 2D image display mode or a 3D image display mode according to the display control signals.

In one aspect of the present invention, color of the first sub-pixel and the second sub-pixel in the same sub-pixel column set is identical, but that of the two adjacent sub-pixel column sets are not identical.

In another aspect of the present invention, the 3D display circular polarizer is used for polarizing displayed images into left-handed or right-handed circularly polarized displayed images when the display device is in the 3D display mode.

In another aspect of the present invention, the 3D display circular polarizer arranges at least one left-handed circular polarization region and at least one right-handed circular polarization region; both the left-handed circular polarization region and the right-handed circular polarization region correspond to one sub-pixel area, and the sub-pixel area is area the first sub-pixel or the second sub-pixel correspond to.

In another aspect of the present invention, the 3D display circular polarizer arranges at least one left-handed circular polarization region and at least one right-handed circular polarization region. Both the left-handed circular polarization region and the right-handed circular polarization region correspond to one sub-pixel area, and the sub-pixel area is area the first sub-pixel or the second sub-pixel correspond to.

In another aspect of the present invention, the first sub-pixel corresponds to one of the left-handed circular polarization region and the right-handed circular polarization region, the second sub-pixel adjacent to the first sub-pixel in a second direction corresponds to the other of the left-handed circular polarization region and the right-handed circular polarization region. The second direction is perpendicular to the first direction.

In another aspect of the present invention, in the first direction, the two adjacent first sub-pixels respectively correspond to the left-handed circular polarization region and the right-handed circular polarization region; in the first direction, the two adjacent second sub-pixels respectively correspond to the right-handed circular polarization region and the left-handed circular polarization region.

In another aspect of the present invention, in the first direction, the two adjacent first sub-pixels both correspond to one of the left-handed circular polarization region and the right-handed circular polarization region; in the first direction, the two adjacent second sub-pixels both correspond to the other of the left-handed circular polarization region and the right-handed circular polarization region.

In another aspect of the present invention, in the 3D image display mode, the control circuit controls a sub-pixel area corresponding to the left-handed circular polarization region to display a first images in a displaying period of one frame of images; in the 3D image display mode, the control circuit further controls a sub-pixel area corresponding to the right-handed circular polarization region to display a second images in a displaying period of a continuous next frame of the one frame.

In still another aspect of the present invention, in a displaying period of any one frame of images, the control circuit controls any two adjacent sub-pixels in the TFT array substrate in the display and the non-display state respectively or in the non-display and the display state respectively.

In yet another aspect of the present invention, in the 2D image display mode, the control circuit also controls the sub-pixel area corresponding to the left-handed circular polarization region and the sub-pixel area corresponding to the right-handed circular polarization region to simultaneously display a third images.

According to the present invention, a method for displaying images using the above display device comprises: using the control circuit to receive display control signals and to switch to a 3D image display mode according to the display control signals; in the 3D image display mode, using the control circuit to control a sub-pixel area corresponding to the left-handed circular polarization region to display a first images in a displaying period of one frame of images; in the 3D image display mode, using the control circuit to control a sub-pixel area corresponding to the right-handed circular polarization region to display a second images in a displaying period of a continuous next frame of the one frame.

In one aspect of the present invention, the method further comprises: using the control circuit to switch to a 2D image display mode according to the display control signals; in the 2D image display mode, using the control circuit to control a sub-pixel area corresponding to the left-handed circular polarization region and a sub-pixel area corresponding to the right-handed circular polarization region to simultaneously display a third image.

Compared to the prior art, the present invention improves 3D image display effect and prevents from human-body fatigue and visual impairment.

These and other features, aspects and advantages of the present disclosure will become understood with reference to the following description, appended claims and accompanying figures.

### BRIEF DESCRIPTION OF THE DRAWINGS

FIG. 1 shows a display device according to a first embodiment of the present invention.

FIG. 2 is a diagram that the display device of the first embodiment in the 2D image display mode.

FIG. 3 and FIG. 4 are respective diagrams that the before and after of two frames of images displayed in the display device in FIG. 2 in the 3D image display mode.

FIG. 5 shows a display device operates in the 2D image display mode according, to a second embodiment of the present invention.

FIG. 6 and FIG. 7 are respective diagrams that the before and after of two frames of images displayed in the display device in FIG. 5 in the 3D image display mode.

FIG. 8 is a flow chart of a method of displaying images using the display device according to the present invention.

### DETAILED DESCRIPTION OF THE PREFERRED

The accompanying drawings are included to provide a further understanding of the invention, and are incorporated in and constitute a part of this specification. The drawings illustrate embodiments of the invention and, together with the description, serve to explain the principles of the invention.

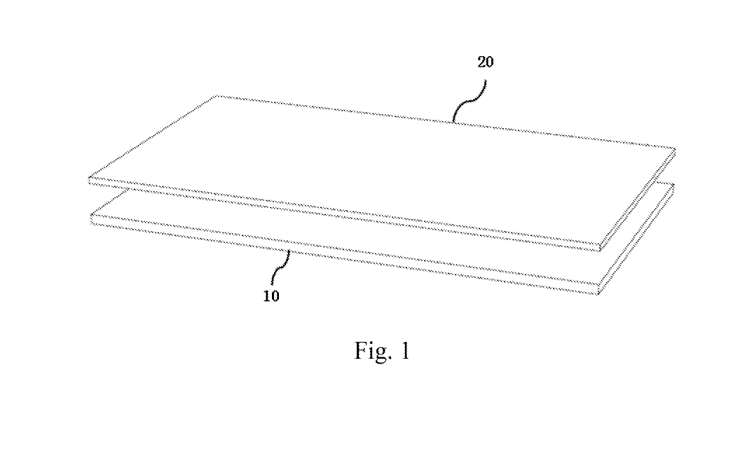

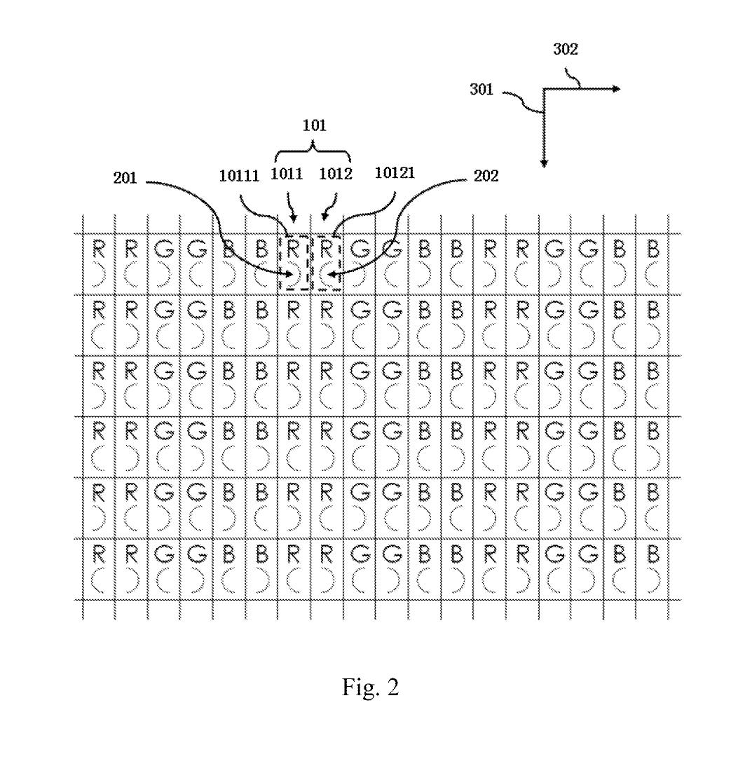

Please refer to FIG. 1 and FIG. 2, FIG. 1 shows a display device according to a first embodiment of the present invention. FIG. 2 is a diagram that the display device of the first embodiment in the 2D image display mode.

The display device of the first embodiment comprises a display panel 10 and a 3D display circular polarizer stacked with the display panel 10. The display panel 10 can be Organic Light Emitting Diode (OLED) or Thin Film Transistor Liquid Crystal Display (TFT-LCD). The display panel 10 comprises a TFT array substrate 20 comprising at least two sub-pixel column sets101 arranged in an array. The sub-pixel column set 101 comprises a first sub-pixel column 1011 and a second sub-pixel column 1012. The first sub-pixel column 1011 and the second sub-pixel column 1012 are arranged in parallel. The first sub-pixel column 1011 comprises at least two of the first sub-pixel columns 10111 arranged in array in the first direction 301, and the second sub-pixel column 1012 comprises at least two of the second sub-pixel columns 10121 arranged in array in the first direction 301. The first direction 301 is parallel to the line where the first sub-pixel column 1011 locates.

The TFT array substrate 20 arranges color resistance (color material) comprising red, green, blue, etc. The color resistance is set up in the area where sub-pixels are. Without doubt, the color resistance is able to be set up on a color filter substrate opposite to the TFT array substrate 20.

The display panel 10 further comprises a control circuit coupled to the TFT array substrate 20. The control circuit is used for receiving display control signals and controlling the display panel 10 to switch display modes between the 2D image and the 3D image according to the display control signals. In particularly, the control circuit turns a pixel switch on the TFT array substrate 20 on or off according to the display control signals so that the correspondent sub-pixel area on the TFT array substrate 20 displays the correspondent images according to image data.

In the embodiment, the color which the first sub-pixel 10111 and the second sub-pixel 10121 in the same sub-pixel column set 101 correspond is identical. That is to say in the whole pixel column set, each sub-pixel in the first sub-pixel column 1011 and the second sub-pixel column 1012 arranged parallelly with each other corresponds to color resistance with the same color (i.e. displaying the same color). Any two of adjacent sub-pixel column sets 101 correspond to different colors. For instance, two adjacent sub-pixel column sets 101 respectively correspond to red and green or green and blue, etc.

In the embodiment, the 3D display circular polarizer is used for polarizing the incident light into left-handed or right-handed circularly polarizing light when the display device is in 3D display mode. The 3D display circular polarizer arranges a plurality of circular polarizing regions. In particular, the 3D display circular polarizer arranges at least one left-handed circular polarization region 202 and at least one right-handed circular polarization region 201. Both the left-handed circular polarization region 202 and the right-handed circular polarization region 201 correspond to one sub-pixel area where the first sub-pixel 10111 and the second sub-pixel 10121 correspond. In particular, the left-handed circular polarization region 202 corresponds to one of the sub-pixel displaying the left-eye images and the sub-pixel displaying the right-eye images, and the right-handed circular polarization region 201 corresponds to the rest of the sub-pixel displaying the left-eye images and to the sub-pixel displaying the right-eye images.

In the embodiment, the first sub-pixel 10111 corresponds to one of the left-handed circular polarization region 202 and the right-handed circular polarization region 201, corresponds to the second sub-pixel 10121 adjacent to the first sub-pixel 10111 in the second direction 302 and corresponds to the rest of the left-handed circular polarization region 202 and the right-handed circular polarization region 201. In other words, in the second direction 302, at least one right-handed circular polarization region 201 exists between any two of the left-handed circular polarization regions 202, and at least one left-handed circular polarization region 202 exists between any two of the right-handed circular polarization regions 201.

In the embodiment, in the first direction 301, two adjacent first sub-pixels 10111 respectively correspond to one of the right-handed circular polarization region 201 and the left-handed circular polarization regions 202, and in the first direction 301, two adjacent second sub-pixels 10121 respectively correspond to the right-handed circular polarization region 201 and the left-handed circular polarization regions 202. That is to say in the first direction 301, at least one right-handed circular polarization region 201 exists between any two of the left-handed circular polarization regions 202, and at least one left-handed circular polarization region 202 exists between any two of right-handed circular polarization regions 201.

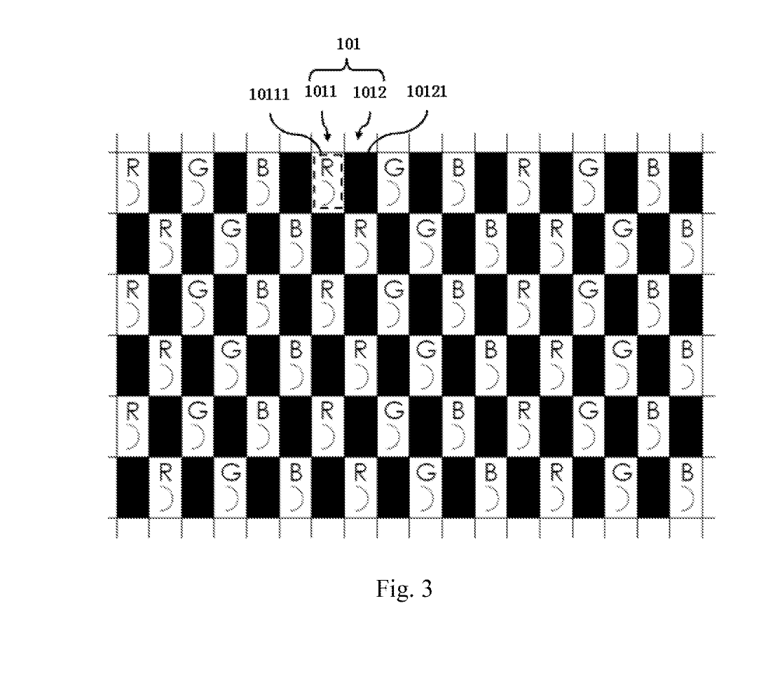

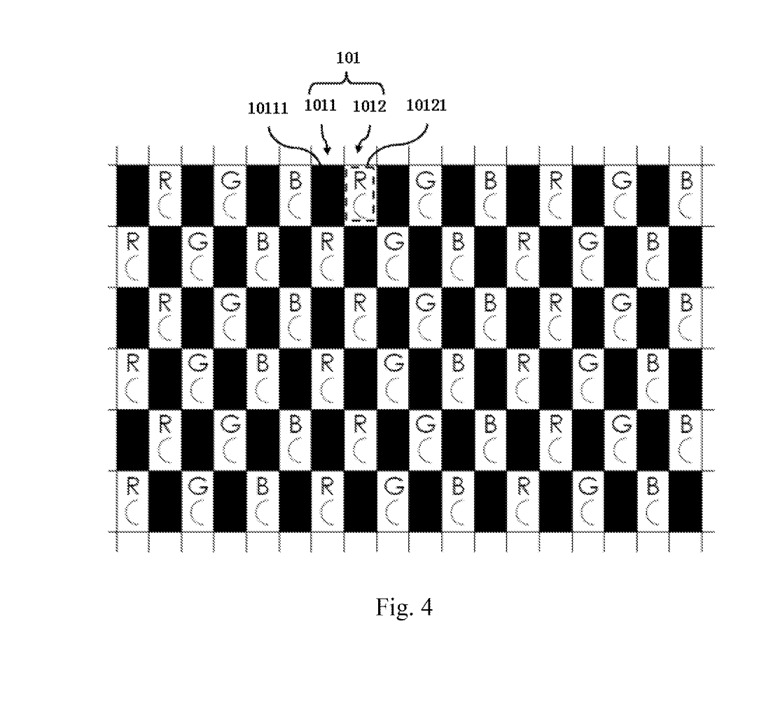

Refer to FIG. 3 and FIG. 4. FIG. 3 and FIG. 4 are respective diagrams that the before and after of two frames of images displayed in the display device in FIG. 2 in the 3D image display mode.

In the embodiment, the control circuit in the 3D image display mode also controls the sub-pixel area corresponding to the left-handed circular polarization region 202 to display a first image in the displaying period of one frame of images(like one of the left-eye and the right-eye images).

In the 3D image display mode, the control circuit further controls the sub-pixel area corresponding to the right-handed circular polarization region 201 to display a second image in the displaying period of the continuous next frame of the one frame (like the other of the left-eye and the right-eye images).

In hence, in the displaying period of any two continuous frames of images (the left-eye and right-eye images), the control circuit controls each sub-pixel in the TFT array substrate 20 (comprising the first sub-pixel 10111 and the second sub-pixel 10121, i.e. the sub-pixel is a general designation of the first sub-pixel 10111 and the second sub-pixel 10121) to switch the display and the non-display state alternatively. Furthermore, in the displaying period of any one frame of images, the control circuit controls any two adjacent sub-pixels in the TFT array substrate 20 in the display and the non-display state respectively (or in the non-display and the display state). The display state corresponds to the left-eye or the right-eye images to be displayed.

In the embodiment, the control circuit in the 2D image display mode also controls the sub-pixel area corresponding to the left-handed circular polarization region 202 and the sub-pixel area corresponding to the right-handed circular polarization region 201 to simultaneously display a third images. In other words, every sub-pixel in the TFT array substrate 20 is in the display state.

According to the scheme, the display device in the present invention improves the 3D image display effect and unlikely results in user fatigue and visual impairment.

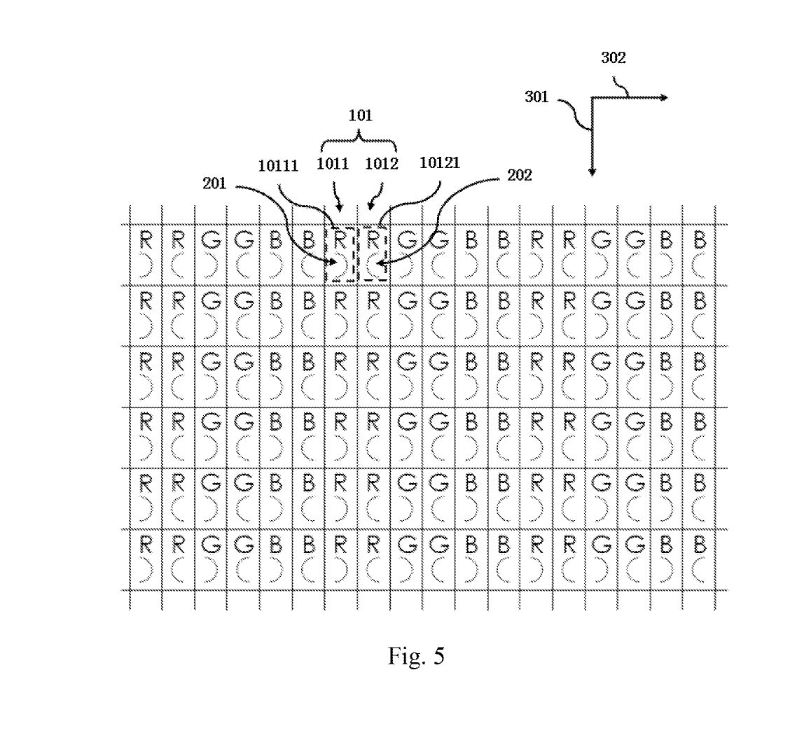

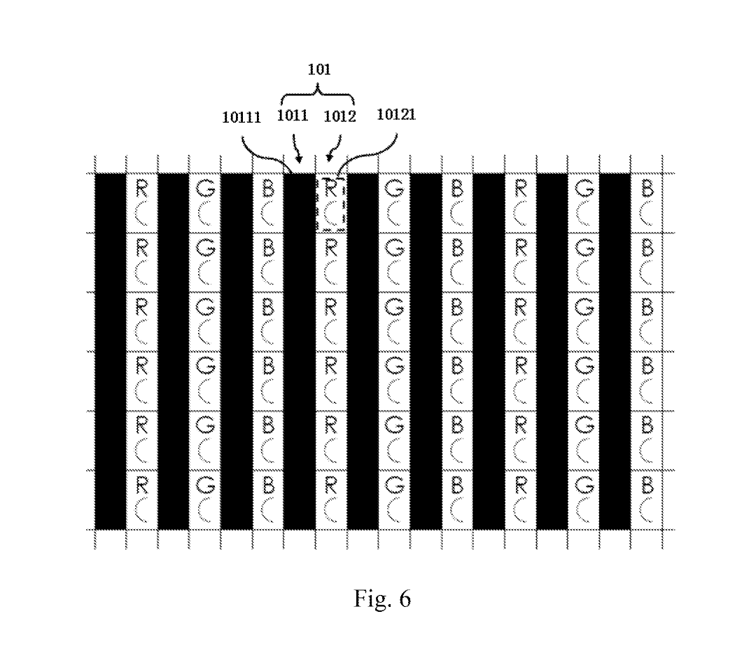

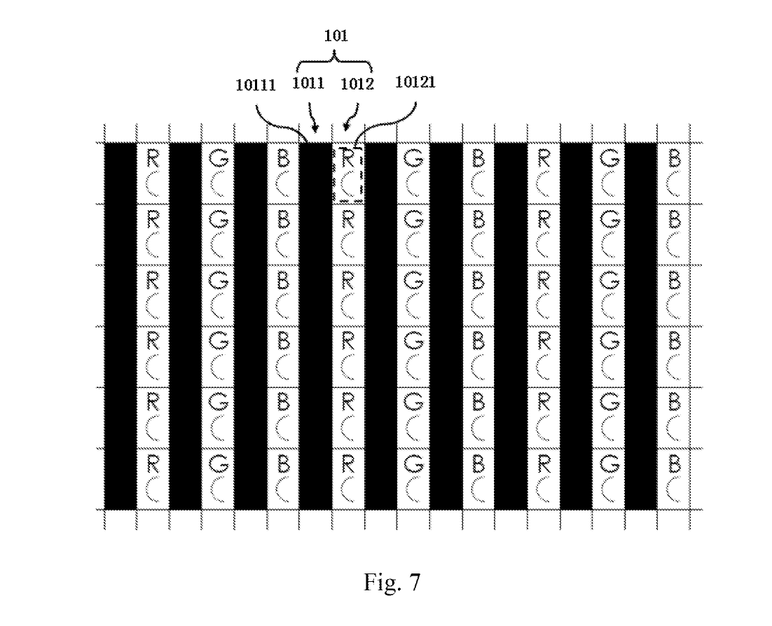

Refer to FIG. 5 to FIG. 7, FIG. 5 shows a display device operates in the 2D image display mode according to a second embodiment of the present invention, FIG. 6 and FIG. 7 are respective diagrams that the before and after of two frames of images displayed in the display device in FIG. 5 in the 3D image display mode.

The display device of the second embodiment according to the present invention is similar to that of the first embodiment, but the difference is that:

In the first direction 301, both two adjacent first sub-pixels 10111 correspond to one of the right-handed circular polarization region 201 and the left-handed circular polarization regions 202, and in the first direction 301, two adjacent second sub-pixels 10121 correspond to the other of the right-handed circular polarization region 201 and the left-handed circular polarization regions 202. That is to say in the first direction 301, any two of the adjacent sub-pixels both correspond to the left-handed circular polarization regions 202, or any two of the adjacent sub-pixels both correspond to the right-handed circular polarization regions 201. The sub-pixels corresponding to the left-handed circular polarization region 202 and the sub-pixels corresponding to the right-handed circular polarization region 201 both are arranged in strip (parallel to the line corresponding to the first direction 301). In addition, the sub-pixel corresponding to the left-handed circular polarization region 202 and the sub-pixel corresponding to the right-handed circular polarization region 201 are set up alternately.

In the displaying period of any two continuous frames of images (the left-eye and the right-eye images), the control circuit controls each sub-pixel in the TFT array substrate 20 (comprising the first sub-pixel 1011 and the second sub-pixel 1012, i.e. the sub-pixel is a general designation of the first sub-pixel 1011 and the second sub-pixel 1012) to switch the display and the non-display state alternatively. In the displaying period of any one frame of images, the control circuit controls any two adjacent sub-pixels in the TFT array substrate 20 in the display and the non-display state respectively (or in the non-display and the display state).

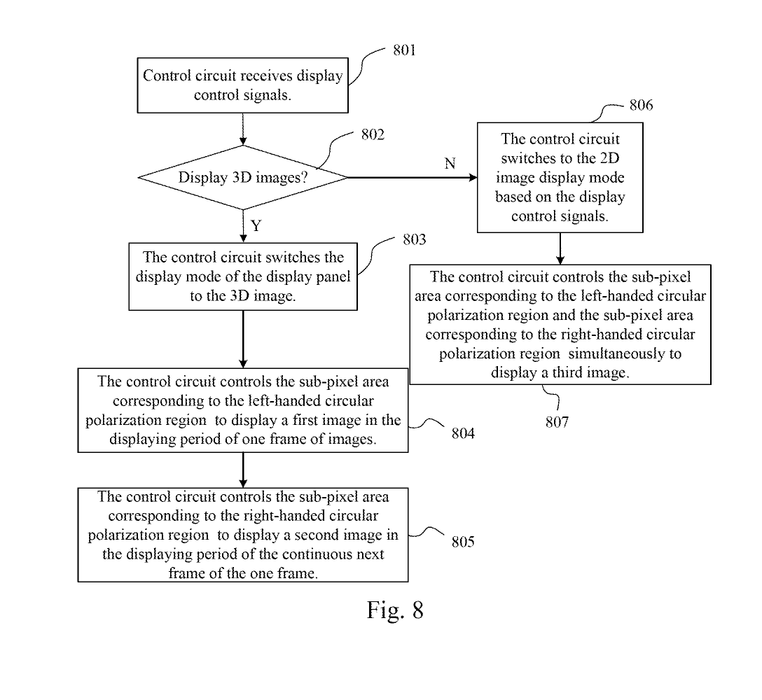

Refer to FIG. 8, FIG. 8 is a flow chart of a method of displaying images using the display device according to the present invention.

The method of the first embodiment for the display device displaying images according to the present invention comprises the following steps:

Step 801, the control circuit receives display control signals.

Step 802, the control circuit determines the display panel 10 to display 3D images or 2D images based on the display control signals, and go to Step 803 if displaying the 3D images, otherwise, go to Step 806.

Step 803, the control circuit switches the display mode of the display panel 10 to the 3D image.

Step 804, in the 3D image display mode, the control circuit controls the sub-pixel area corresponding to the left-handed circular polarization region 202 to display a first image in the displaying period of one frame of images.

Step 805, in the 3D image display mode, the control circuit further controls the sub-pixel area corresponding to the right-handed circular polarization region 201 to display a second image in the displaying period of the continuous next frame of the one frame.

In hence, in the displaying period of any two continuous frames of images (the left-eye and the right-eye images), the control circuit controls each sub-pixel in the TFT array substrate 20 to switch the display and the non-display state alternatively. In the displaying period of any one frame of images, the control circuit controls any two adjacent sub-pixels in the TFT array substrate 20 in the display and the non-display state respectively (or in the non-display and the display state).

Or, in the displaying period of any two continuous frames of images (the left-eye and the right-eye images), the control circuit controls each sub-pixel column in the TFT array substrate 20 to switch the display and the non-display state alternatively. In the displaying period of any one frame of images, the control circuit controls any two adjacent sub-pixel columns in the TFT array substrate 20 in the display and the non-display state respectively (or in the non-display and the display state).

Step 806, the control circuit switches to the 2D image display mode based on the display control signals.

Step 807, in the 2D image display mode, the control circuit controls the sub-pixel area corresponding to the left-handed circular polarization region 202 and the sub-pixel area corresponding to the right-handed circular polarization region 201 simultaneously to display a third image.

According to the scheme, the display device in the present invention improves the 3D image display effect and unlikely results in user fatigue and visual impairment.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A display device comprising a display panel, the display panel comprising:
a Thin Film Transistor (TFT) array substrate comprising at least two sub-pixel column sets, at least two of the sub-pixel column sets arranged in array, wherein the sub-pixel column sets comprises:
a first sub-pixel column and a second sub-pixel column set up in parallel, the first sub pixel column comprising at least two first sub-pixels, at least two of the first sub-pixels arranged in array in the first direction, the second sub-pixel column comprising at least two second sub-pixels, at least two of the second sub-pixels arranged in array in the first direction;
wherein, the first direction is parallel to a line where the first sub-pixel column locates;
a 3D display circular polarizer stacked with the display panel;
a control circuit for receiving display control signals and controlling the display panel to switch to a 2D image display mode or a 3D image display mode according to the display control signals;
color of the first sub-pixel and the second sub-pixel in the same sub-pixel column set is identical, but that of the two adjacent sub-pixel column sets are not identical;
the 3D display circular polarizer is used for polarizing displayed images into left-handed or right-handed circularly polarized displayed images when the display device is in the 3D display mode.

2. The display device of claim 1, wherein
the 3D display circular polarizer arranges at least one left-handed circular polarization region and at least one right-handed circular polarization region;
both the left-handed circular polarization region and the right-handed circular polarization region correspond to one sub-pixel area, and the sub-pixel area is area the first sub-pixel or the second sub-pixel correspond to.

3. The display device of claim 2, wherein
the first sub-pixel corresponds to one of the left-handed circular polarization region and the right-handed circular polarization region, the second sub-pixel adjacent to the first sub-pixel in a second direction corresponds to the other of the left-handed circular polarization region and the right-handed circular polarization region;
wherein the second direction is perpendicular to the first direction.

4. The display device of claim 3, wherein
in the first direction, the two adjacent first sub-pixels respectively correspond to the left-handed circular polarization region and the right-handed circular polarization region;
in the first direction, the two adjacent second sub-pixels respectively correspond to the right-handed circular polarization region and the left-handed circular polarization region.

5. The display device of claim 3, wherein
in the first direction, the two adjacent first sub-pixels both correspond to one of the left-handed circular polarization region and the right-handed circular polarization region;
in the first direction, the two adjacent second sub-pixels both correspond to the other of the left-handed circular polarization region and the right-handed circular polarization region.

6. The display device of claim 2, wherein
in the 3D image display mode, the control circuit controls a sub-pixel area corresponding to the left-handed circular polarization region to display a first images in a displaying period of one frame of images;
in the 3D image display mode, the control circuit further controls a sub-pixel area corresponding to the right-handed circular polarization region to display a second images in a displaying period of a continuous next frame of the one frame.

7. The display device of claim 6, wherein
in a displaying period of any one frame of images, the control circuit controls any two adjacent sub-pixels in the TFT array substrate in the display and the non-display state respectively or in the non-display and the display state respectively.

8. The display device of claim 2, wherein
in the 2D image display mode, the control circuit also controls the sub-pixel area corresponding to the left-handed circular polarization region and the sub-pixel area corresponding to the right-handed circular polarization region to simultaneously display a third images.

9. A display device comprising a display panel, the display panel comprises:
a Thin Film Transistor (TFT) array substrate comprising at least two sub-pixel column sets, at least two of the sub-pixel column sets arranged in array, wherein the sub-pixel column sets comprises:
a first sub-pixel column and a second sub-pixel column set up in parallel, the first sub-pixel column comprising at least two first sub-pixels, at least two of the first sub-pixels arranged in array in the first direction, the second sub-pixel column comprising at least two second sub-pixels, at least two of the second sub-pixels arranged in array in the first direction;
wherein, the first direction is parallel to a line where the first sub-pixel column locates;
a 3D display circular polarizer stacked with the display panel;
a control circuit for receiving display control signals and controlling the display panel to switch to a 2D image display mode or a 3D image display mode according to the display control signals.

10. The display device of claim 9, wherein color of the first sub-pixel and the second sub-pixel in the same sub-pixel column set is identical, but that of the two adjacent sub-pixel column sets are not identical.

11. The display device of claim 9, wherein the 3D display circular polarizer is used for polarizing displayed images into left-handed or right-handed circularly polarized displayed images when the display device is in the 3D display mode.

12. The display device of claim 9, wherein the 3D display circular polarizer arranges at least one left-handed circular polarization region and at least one right-handed circular polarization region;
both the left-handed circular polarization region and the right-handed circular polarization region correspond to one sub-pixel area, and the sub-pixel area is area the first sub-pixel or the second sub-pixel correspond to.

13. The display device of claim 12, wherein the first sub-pixel corresponds to one of the left-handed circular polarization region and the right-handed circular polarization region, the second sub-pixel adjacent to the first sub-pixel in a second direction corresponds to the other of the left-handed circular polarization region and the right-handed circular polarization region;
wherein the second direction is perpendicular to the first direction.

14. The display device of claim 13, wherein
in the first direction, the two adjacent first sub-pixels respectively correspond to the left-handed circular polarization region and the right-handed circular polarization region;
in the first direction, the two adjacent second sub-pixels respectively correspond to the right-handed circular polarization region and the left-handed circular polarization region.

15. The display device of claim 13, wherein
in the first direction, the two adjacent first sub-pixels both correspond to one of the left-handed circular polarization region and the right-handed circular polarization region;
in the first direction, the two adjacent second sub-pixels both correspond to the other of the left-handed circular polarization region and the right-handed circular polarization region.

16. The display device of claim 12, wherein
in the 3D image display mode, the control circuit controls a sub-pixel area corresponding to the left-handed circular polarization region to display a first images in a displaying period of one frame of images;
in the 3D image display mode, the control circuit further controls a sub-pixel area corresponding to the right-handed circular polarization region to display a second images in a displaying period of a continuous next frame of the one frame.

17. The display device of claim 16, wherein
in a displaying period of any one frame of images, the control circuit controls any two adjacent sub-pixels in the TFT array substrate in the display and the non-display state respectively or in the non-display and the display state respectively.

18. The display device of claim 12, wherein
in the 2D image display mode, the control circuit also controls the sub-pixel area corresponding to the left-handed circular polarization region and the sub-pixel area corresponding to the right-handed circular polarization region to simultaneously display a third images.

19. A method for displaying images using the display device of claim 9, comprising:
using the control circuit to receive display control signals and to switch to a 3D image display mode according to the display control signals;
in the 3D image display mode, using the control circuit to control a sub-pixel area corresponding to the left-handed circular polarization region to display a first images in a displaying period of one frame of images;
in the 3D image display mode, using the control circuit to control a sub-pixel area corresponding to the right-handed circular polarization region to display a second images in a displaying period of a continuous next frame of the one frame.

20. The method of claim 19 further comprising:
using the control circuit to switch to a 2D image display mode according to the display control signals;
in the 2D image display mode, using the control circuit to control a sub-pixel area corresponding to the left-handed circular polarization region and a sub-pixel area corresponding to the right-handed circular polarization region to simultaneously display a third image.
